(19) United States
(12) Patent Application Publication
(10) Pub. No.: US 2004/0061375 A1
(43) Pub. Date: Apr. 1, 2004

(54) Electrohydraulic brake system for motor vehicles

(76) Inventors: Peter Drott, Frankfurt/Main (DE); Bernhard Giers, Frankfurt (DE); Thomas Gobel, Frankfurt (DE); Horst Kramer, Ginsheim-Gustavsburg (DE); Holger Kranlich, Karben (DE); Andreas Klein, Bad Homburg (DE); Holger Wahl, Wallrabenstein (DE); Jan Hoffmann, Rochester Hills, MI (US); Andreas Emmerich, Oberursel (DE); Uwe Karl, Wiesbaden (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/467,386

(22) PCT Filed: Feb. 12, 2002
(86) PCT No.: PCT/EP02/01453

(30) Foreign Application Priority Data
Feb. 12, 2001 (DE) 101 06 790.9
Feb. 23, 2001 (DE) 101 08 659.8
May 15, 2001 (DE) 101 23 599.2

(51) Int. Cl. B60T 13/66

(52) U.S. Cl. 303/20; 303/15

(57) ABSTRACT

The present invention relates to an electrohydraulic brake system for motor vehicles which is controllable in a ‘brake-by-wire’ mode of operation by the vehicle operator as well as irrespective of the vehicle operator, is operated preferably in the brake-by-wire mode of operation, and can be operated in a fallback mode of operation in which only operation by the vehicle operator is possible.

To enhance the safety of operation of the brake system and to disclose a brake system, in which a sufficient amount of pressure fluid volume is available in all driving situations, the invention discloses the provision of a means for making available a pressure fluid volume flow that ensures in the fallback mode of operation at least the pressure fluid volume needed for the respectively required deceleration.

The present invention relates to an electrohydraulic brake system for motor vehicles which is controllable in a ‘brake-by-wire’ mode of operation by the vehicle operator as well as irrespective of the vehicle operator, is preferably operated in the brake-by-wire mode of operation, and can be operated in a fallback mode of operation in which only operation by the vehicle operator is possible, including

a master brake cylinder operable by means of a brake pedal and having at least one pressure chamber,

a travel simulator cooperating with the master brake cylinder and having a simulator piston positioned by means of a spring, said simulator piston limiting a simulator compartment accommodating the spring, on the one hand, and a simulator compartment communicating with one of the pressure chambers of the master brake cylinder, on the other hand,

an unpressurized pressure fluid reservoir,

a hydraulic auxiliary pressure source,

an electronic controlling and regulating unit, and

wheel brakes connectable to the master brake cylinder and the hydraulic pressure source.

International patent application WO 00/43246 discloses a brake system of this type. In the prior art brake system, an electrically operable by-pass valve being closed with each braking operation is inserted into a hydraulic line between the travel simulator and the pressure fluid reservoir. When malfunction occurs in said known brake system, causing the control unit and/or the power supply of the electrically operated assemblies to fail, it is impossible to open the by-pass valve so that the travel simulator is shut off and cannot take up pressure fluid volume. The pressure introduced into the wheel brakes effects resetting of the simulator piston or the brake pedal into the initial position.

However, the overall balance of the pressure fluid volume that occurs e.g. when driving on a slippery roadway is considered a shortcoming. After the travel simulator received a defined pressure fluid volume, the pressure prevailing in the wheel brakes is regulated down to zero by ABS intervention so that resetting of the simulator piston is impossible. Therefore, the prior art system is unable to provide the pressure fluid volume taken up in the travel simulator.

In view of the above, an object of the present invention is to increase the reliability of operation of the brake system of the type mentioned hereinabove and to disclose a brake system, in which a sufficient amount of pressure fluid volume is made available in all driving situations.

This object is achieved according to the invention by providing a means for making available a pressure fluid volume flow that ensures in the fallback mode of operation at least the pressure fluid volume needed for the respectively required deceleration.

To render the idea of the invention more concrete, provision is made that the means safeguards an active return delivery of the pressure fluid volume taken up by the travel simulator into the master brake cylinder. Return delivery is effected preferably by means of the energy generated by the hydraulic auxiliary pressure source.

In an advantageous improvement of the subject matter of the invention, the auxiliary pressure source is a chargeable high-pressure accumulator, and a valve assembly is provided which, in the brake-by-wire mode of operation, opens a hydraulic connection between the travel simulator and the pressure fluid reservoir and closes a hydraulic connection between the travel simulator and the high-pressure accumulator, while it closes the hydraulic connection between the travel simulator and the pressure fluid reservoir and opens the hydraulic connection between the travel simulator and the high-pressure accumulator in the fallback mode of operation.

The simulator piston is acted upon by the pressure provided by the high-pressure accumulator preferably in the fallback mode of operation in opposition to its direction of movement corresponding to the brake-by-wire mode of operation.

An advantageous improvement of the subject matter of the invention arranges for the auxiliary pressure source to be a chargeable high-pressure accumulator, and a valve assembly is provided which, in the brake-by-wire mode of operation, opens a hydraulic connection between a hydraulic chamber of a piston-and-cylinder assembly and the pressure fluid reservoir and closes a hydraulic connection between the hydraulic chamber and the high-pressure accumulator, while it closes the hydraulic connection between the hydraulic chamber and the pressure fluid reservoir and opens the hydraulic connection between the hydraulic chamber and the high-pressure accumulator in the fallback mode of operation, the said hydraulic chamber being limited by a hydraulic piston to which the pressure provided by the high-pressure accumulator is applied and which, in the fallback mode of operation, displaces the simulator piston in opposition to its direction of movement that corresponds to the brake-by-wire mode of operation.

In another embodiment of the invention, the simulator piston is displaced by a mechanical actuating element that is operated by means of a resetting spring adapted to be compressed by the pressure provided by the high-pressure accumulator. Part of the actuating element is suitably configured as a hydraulic piston.

In this arrangement it is especially favorable that the hydraulic piston separates a first pressure chamber from a second pressure chamber, and that a valve assembly is provided that opens a hydraulic connection between the first pressure chamber and the high-pressure accumulator and closes a hydraulic connection between the pressure chamber and the pressure fluid reservoir in the brake-by-wire mode of operation, while it closes the hydraulic connection between the first pressure chamber and the high-pressure accumulator and opens the hydraulic connection between the first pressure chamber and the pressure fluid reservoir in the fallback mode of operation.

In another favorable variant of the subject matter of the invention, the means safeguard inflow of an of additional pressure fluid volume into the master brake cylinder, said additional pressure fluid volume being provided by the hydraulic auxiliary pressure source.

Besides, it is especially suitable when a hydraulic connection closable by means of a valve is interposed between the high-pressure accumulator and at least one of the pressure chambers of the master brake cylinder.

A separating piston device can be inserted into the hydraulic connection and is connected to the pressure fluid reservoir by means of a closable line.

In another favorable embodiment of the subject matter of the invention, the master brake cylinder is configured as a tandem master cylinder with a first and a second pressure chamber being limited by a first and a second piston, and the valve is operable by movement of the second piston.

Further details, features, and advantages of this invention can be taken from the following description a total of nine embodiments making reference to the accompanying schematic drawings, wherein like reference numerals have been assigned to like components. In the drawings,

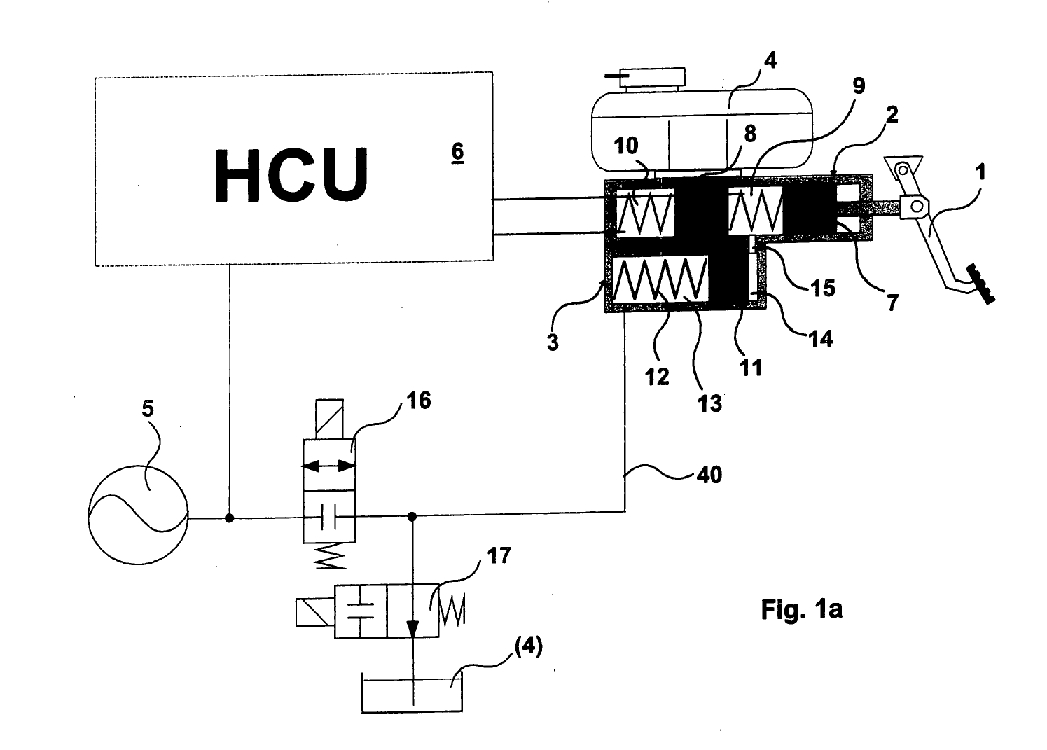

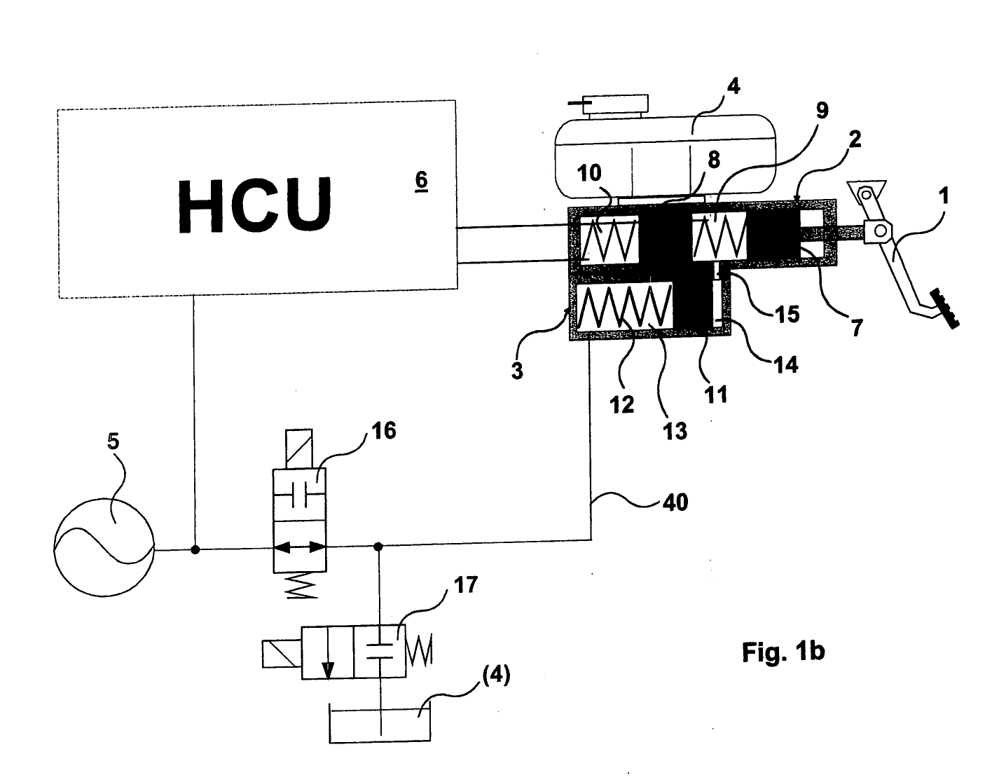

FIG. 1a shows the design of the brake system of the invention according to a first embodiment in the active or standby condition.

FIG. 1b shows the brake system of FIG. 1a in the inactive or de-energized condition.

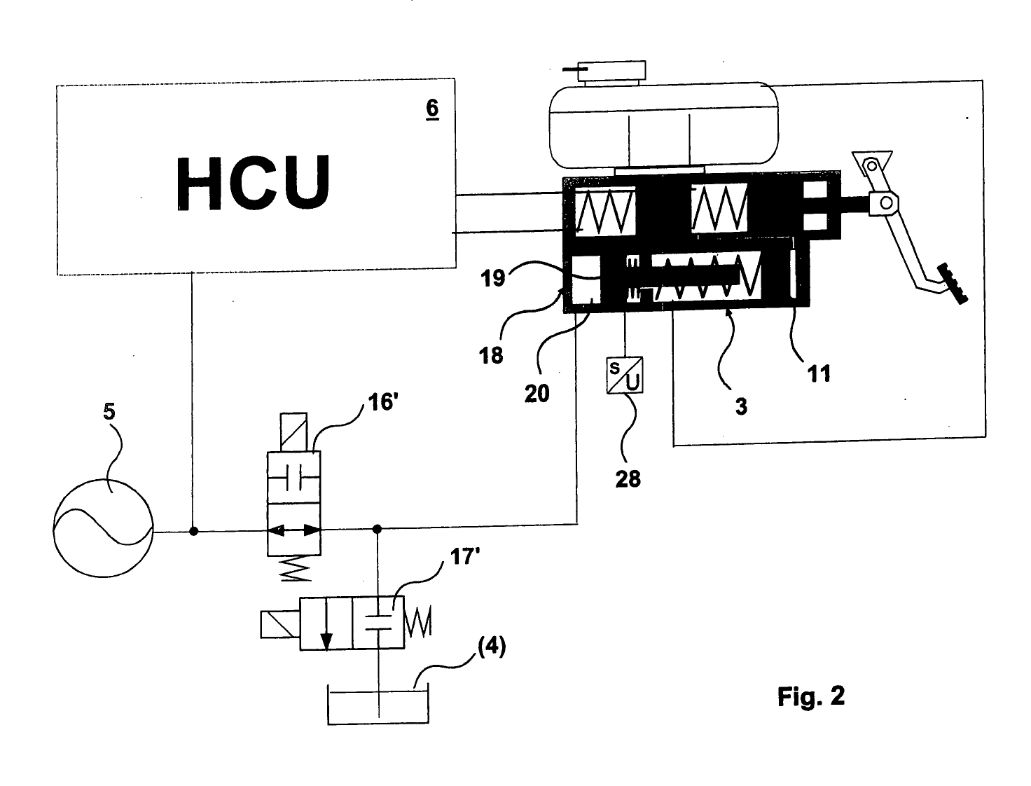

FIG. 2 shows the design of a second embodiment of the brake system of the invention in the inactive or de-energized condition.

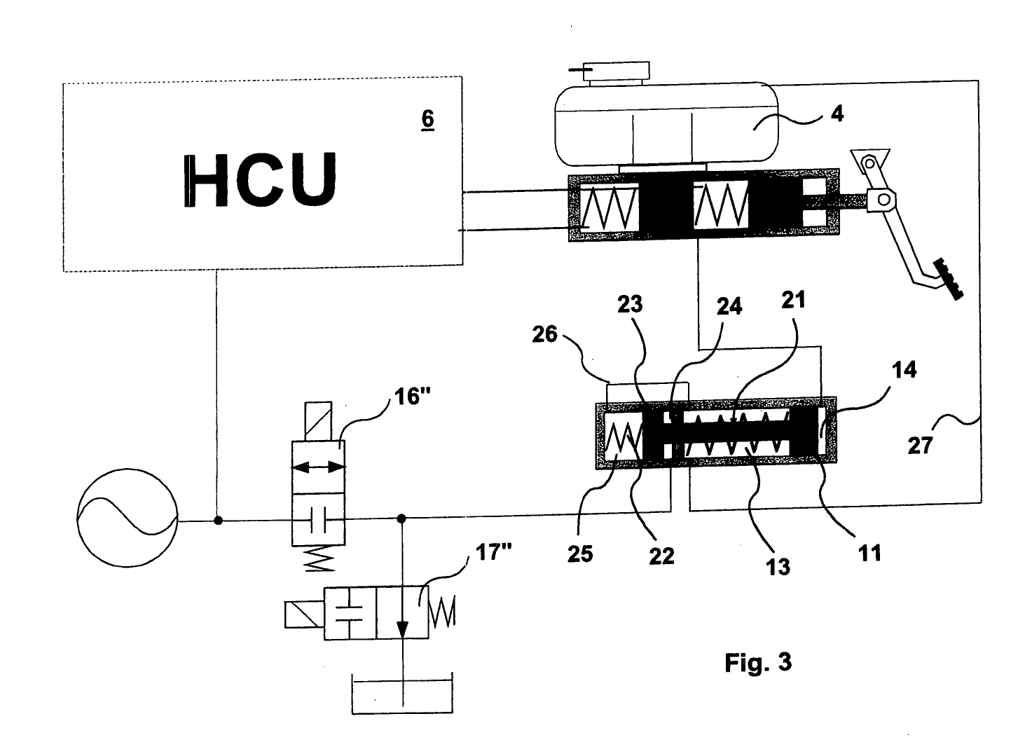

FIG. 3 shows the design of a third embodiment of the brake system of the invention in the inactive or de-energized condition.

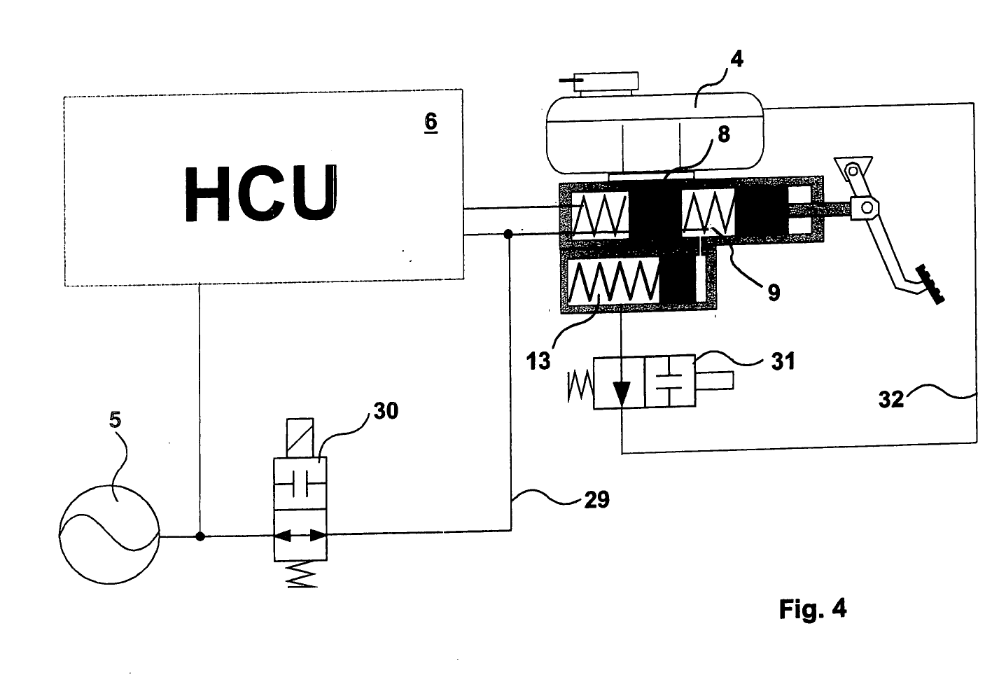

FIG. 4 shows the design of a fourth embodiment of the brake system of the invention in the inactive or de-energized condition.

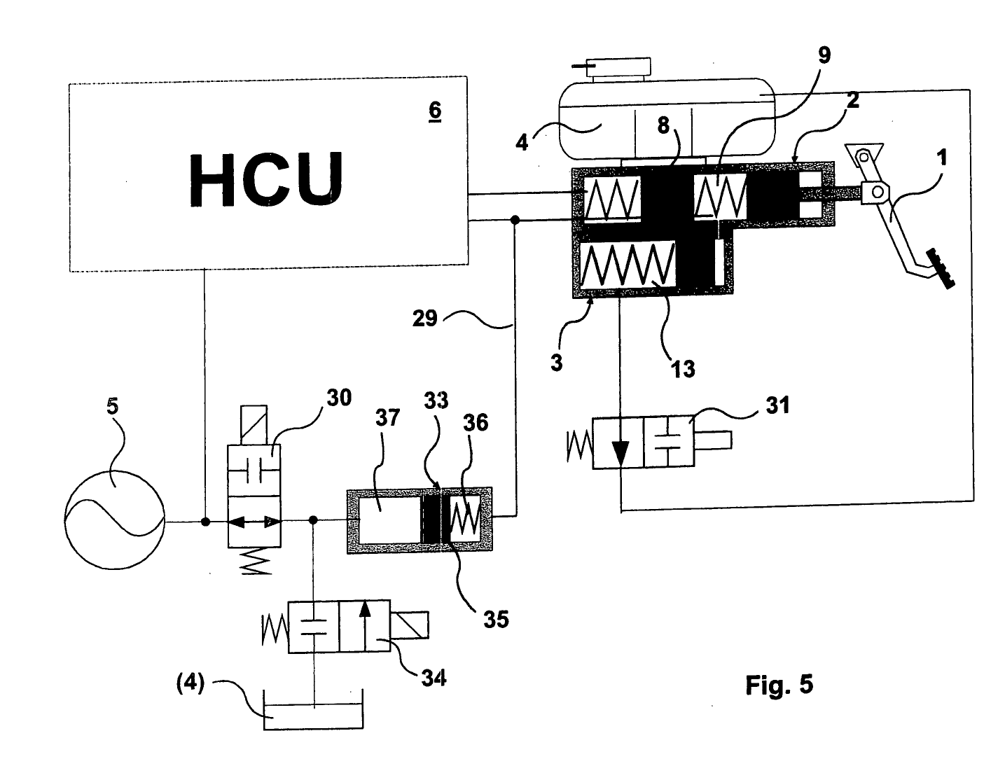

FIG. 5 shows a first modification of the embodiment of the brake system of the invention illustrated in FIG. 4 in the inactive or de-energized condition.

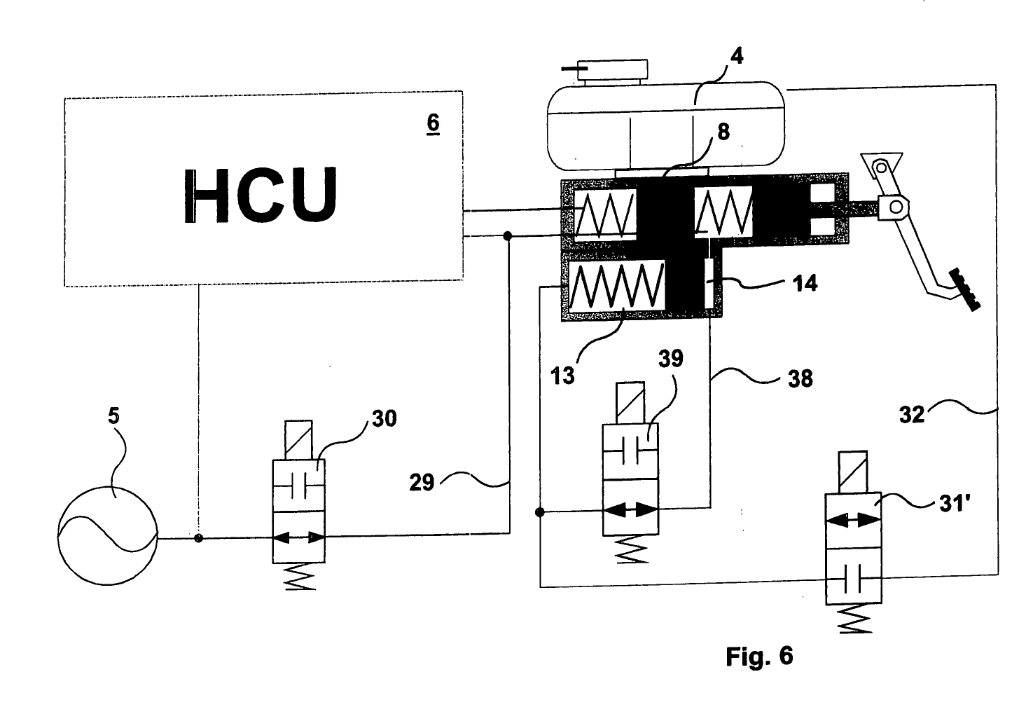

FIG. 6 shows a second modification of the embodiment of the brake system of the invention illustrated in FIG. 4 in the inactive or de-energized condition.

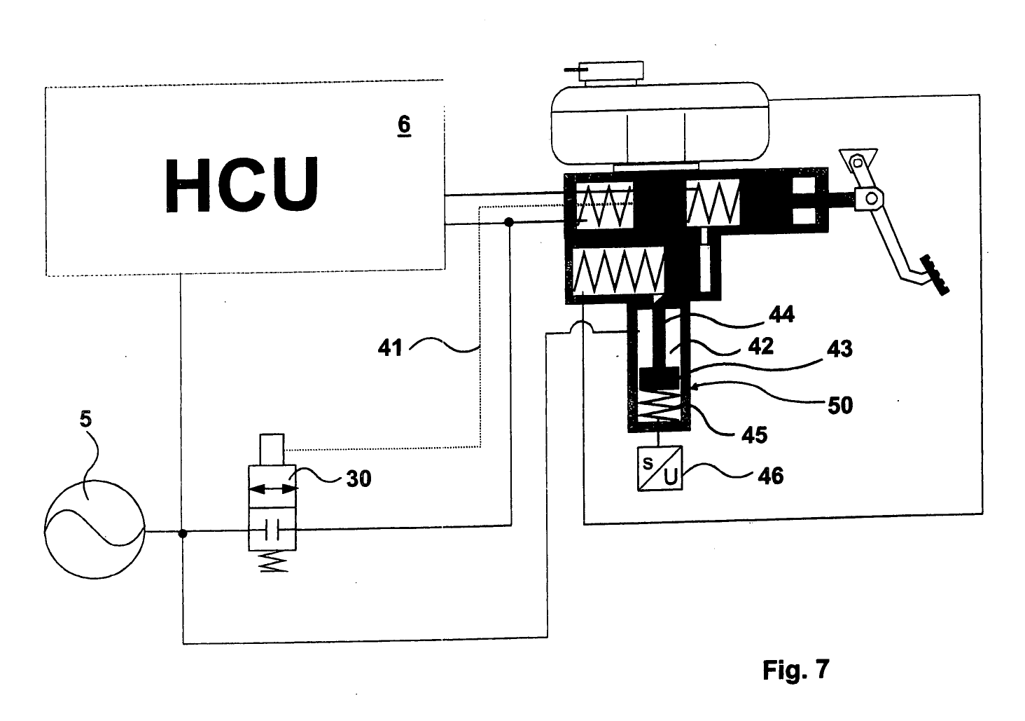

FIG. 7 shows a third modification of the embodiment of the brake system of the invention illustrated in FIG. 4 in the inactive or de-energized condition.

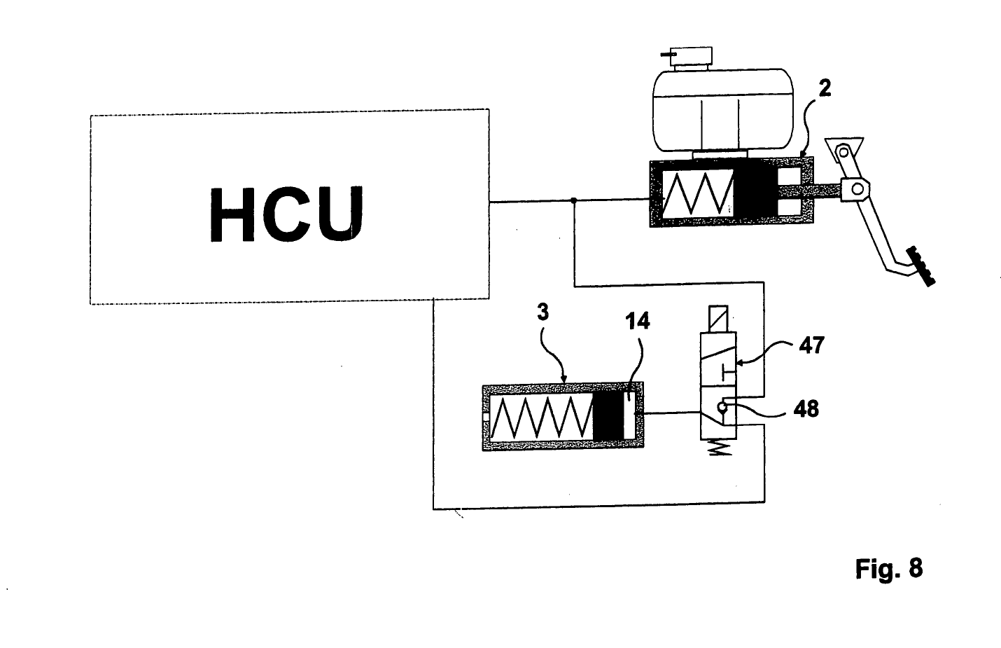

FIG. 8 shows a fifth embodiment of the brake system of the invention.

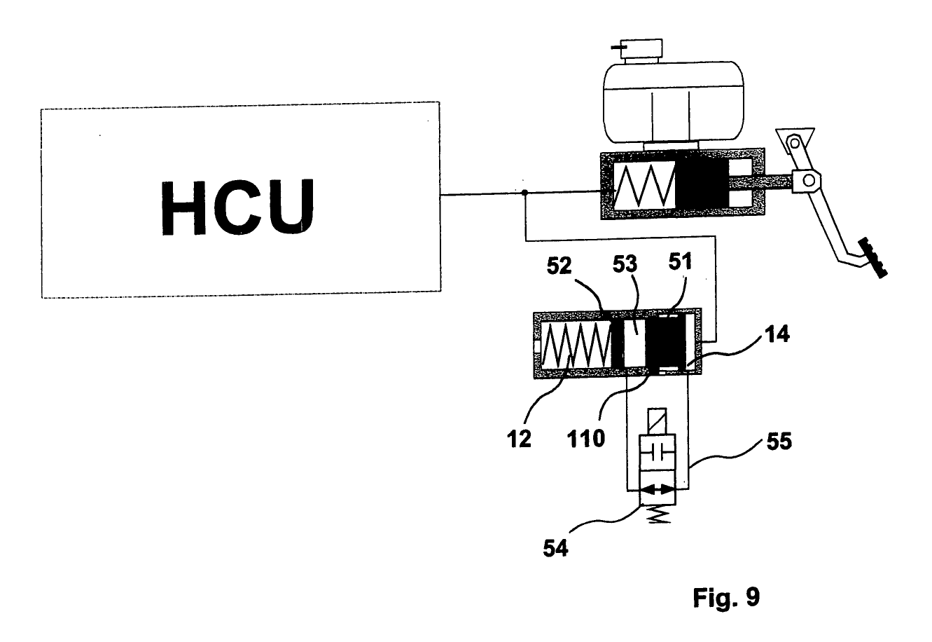

FIG. 9 shows a sixth embodiment of the brake system of the invention.

The brake system illustrated only schematically in the drawings is essentially composed of a dual-circuit hydraulic pressure generator or master brake cylinder 2 in tandem design that is operable by means of a brake pedal 1, a travel simulator 3 cooperating with the tandem master cylinder 2, a pressure fluid reservoir 4 assigned to the tandem master cylinder 2, a hydraulic auxiliary pressure source 5, a hydraulic control unit HCU 6 (only represented) that comprises, among others, all components necessary for pressure control operations and to which non-illustrated vehicle brakes are connected, as well as an electronic controlling and regulating unit (not shown). The per se known tandem master cylinder 2 includes pressure chambers 9, 10 isolated from one another by two pistons 7, 8 and being connectable with the pressure fluid reservoir 4 and with the vehicle brakes by way of HCU 6. The above-mentioned travel simulator 3 that imparts to the driver the usual brake pedal feeling in the brake-by-wire mode basically comprises a simulator piston 11 and a spring 12 supported on the simulator piston 11 and being arranged in a simulator chamber 13 confined by the simulator piston 11. On the other hand, said simulator piston 11 limits a simulator chamber 14 that is connected to the first pressure chamber 9 of the tandem master cylinder 2 by means of a pressure fluid channel 15 and, thus, can be acted upon by the introduced hydraulic pressure. Further, it can be taken from FIGS. 1a and 1b that a hydraulic line 40 is provided between the auxiliary pressure source 5, being preferably formed by a high-pressure accumulator, and the simulator chamber 13, said line 40 being adapted to be closed or opened by means of an electromagnetically operable, preferably normally open (NO) two-way/two-condition directional control valve 16. Further, the simulator chamber 13 is connected to an unpressurized pressure fluid reservoir by way of an electromagnetically operable, preferably normally closed (NC) two-way/two-condition directional control valve 17, which reservoir—as indicated by reference numeral (4)—can be formed of the above-mentioned pressure fluid reservoir 4.

The mode of function of the brake system of the invention illustrated in FIGS. 1a,b is explained in detail in the following text.

In the non-depressed condition of brake pedal 1 all components assume their positions shown in FIG. 1a. In the preferred brake-by-wire mode of operation the driver's request for deceleration sensed at the brake pedal 1 by means of a travel sensor (not shown) is converted in the previously mentioned electronic control unit into a system pressure value to be input into the vehicle brakes and being adjusted by means of HCU 6. Tandem master cylinder 2 is then isolated from the vehicle brakes. Movement of the first master cylinder piston 7 in the actuating direction causes pressurization of simulator piston 11, and thus, its displacement to the left in the drawing so that a pedal feeling predetermined by the characteristic curve of spring 12 is imparted to driver when depressing the brake pedal 1. The pressure fluid volume displaced from the simulator chamber 13 is shifted into the pressure fluid reservoir (4) by way of the open valve 17.

In the event of power failure e.g. caused by a battery defect, a short-circuit or switch-off of the ignition, the brake system of the invention automatically changes over to a first fallback mode of operation rendering braking operations by the driver possible. As this occurs the valves 16, 17 are switched to assume the switch position shown in FIG. 1b so that the connection between the simulator chamber 13 and the pressure fluid reservoir 4 is interrupted. The pressure provided by the high-pressure accumulator 5 is then applied to the end surface of the simulator piston 11 facing spring 12, with the result that the simulator piston 11 returns into its initial position and the pressure fluid volume received in the simulator chamber 14 is delivered back into the first pressure chamber 9 of the tandem master cylinder 2.

In the embodiment shown in FIG. 2, a piston-and-cylinder assembly 18 is connected upstream of the travel simulator 3 in terms of effect, the piston 19 of which is movable into a force-transmitting connection with the simulator piston 11. Piston 19 defines a hydraulic chamber 20 that is connectable to the high-pressure accumulator 5 or the pressure fluid reservoir 4 by way of the valve assembly 16, 17 mentioned with respect to FIG. 1. It can clearly be seen in the drawings that the hydraulic chamber 20 is isolated from the pressure fluid reservoir 4 and connected to the high-pressure accumulator 5 in the switch position of the valves 16, 17 that corresponds to the illustrated fallback mode of operation, with the result that the piston 19 is displaced to the right in the drawing and resets the simulator piston 11. The resetting movement of the simulator piston 11 into the initial position causes displacement of the pressure fluid volume received in simulator chamber 14 into the master brake cylinder 2. A travel sensor 28 only represented permits monitoring the position of piston 19.

In the design of the object of the invention shown in FIG. 3 the simulator piston 11 in the fallback mode of operation is reset by the action of a resetting spring 22 cooperating with a mechanical actuating element 21. The end of actuating element 21 remote from the simulator piston 11 is configured as a hydraulic piston 23 that isolates a first pressure chamber 24 from a second pressure chamber 25. In this arrangement, the first pressure chamber 24 can be acted upon by the pressure the high-pressure accumulator 5 provides, while the second pressure chamber 25 accommodates the resetting spring 22 so that the actuating element 21 is moved to the left and the resetting spring 22 compressed when valve 16 opens and valve 17 closes. In the switch position of valves 16, 17 that is shown in FIG. 3 and corresponds to the fallback mode of operation, the connection between the first pressure chamber 24 and the pressure fluid reservoir 4 is opened so that the resetting spring 22 can get released and displace the actuating element 21 to the right in the drawing. The simulator piston 11 is thus returned into its initial position, as described in the cases hereinabove.

In the example shown in FIG. 3 both the simulator chamber 13 and the second pressure chamber 25 have a wet design, meaning they are filled with pressure fluid. As the pressure fluid is displaced out of the simulator chamber 13 and the second pressure chamber 25 upon movement of the simulator piston 11 and the actuating element 21, hydraulic connections 26, 27 are arranged between the second pressure chamber 25 and the simulator chamber 13 and between the simulator chamber 13 and the pressure fluid reservoir 4. It is, of course, also feasible to provide both the simulator chamber 13 and the second pressure chamber 25 in a dry design, i.e., to connect them to the atmosphere, thereby obviating the need for the hydraulic connections 26, 27.

In the examples shown in FIGS. 4 to 6 the master brake cylinder 2 in the fallback mode of operation is supplied with additional pressure fluid volume being preferably furnished from the hydraulic auxiliary pressure source of the high-pressure accumulator 5. For this purpose, the design illustrated in FIG. 4 arranges for a hydraulic connection 29 between the first pressure chamber 9 of the tandem master cylinder 2 and the high-pressure accumulator 5, wherein an electrically operable normally open (NO) valve 30 is inserted. A mechanically operable valve 31, only represented, in line 32 between the simulator chamber 13 and the pressure fluid reservoir 4 permits closing the simulator chamber 13 in the fallback mode of operation, with the valve 31 being actuated, for example, by the movement of the second master cylinder piston 8. In the design described, the high-pressure accumulator 5 is discharged completely in the event of power failure. It is, however, also possible to design the valve 30 inserted in the connection 29 between the high-pressure accumulator 5 and the first pressure chamber 9 of the master brake cylinder 2 as a mechanically operable two-way/two-position directional control valve that is operated by way of the second master cylinder piston 8.

The construction illustrated in FIG. 5 largely corresponds to the design in FIG. 4. However, the difference resides in that the above-mentioned connection 29 includes a separating piston device 33 comprising a separating piston 35 preloaded by a spring 36. Separating piston 35 limits a pressure chamber 37 that is connected to the pressure fluid reservoir 4 by way of an electrically operable, preferably normally closed (NC) valve 34. It is achieved by this measure that the high-pressure accumulator 5 in the fallback mode of operation supplies a dosed quantity of pressure fluid and is not emptied completely.

Likewise the design shown in FIG. 6 largely corresponds to the design according to FIG. 4. Valve 31′ inserted into line 32 is, however, configured as an electromagnetically operable, normally closed (NC) two-way/two-position directional control valve, with a pressure compensating line 38 being provided between the simulator chamber 13 and the simulator chamber 14 that is adapted to be closed or opened by means of an equally electromagnetically operable, preferably normally open (NO) two-way/two-position directional control valve 39. The simulator function is disabled upon power failure by the pressure balance between the simulator chamber 13 and the simulator chamber 14. It is possible also in this design to configure the valve 30 inserted in the connection 29 between the high-pressure accumulator 5 and the first pressure chamber 9 of the master brake cylinder 2 as a mechanically operable two-way/two-position directional control valve that is actuated by means of the second master cylinder piston 8.

In the fifth design of the object of the invention illustrated in FIG. 7, whose construction basically corresponds to the arrangement shown in FIG. 4, the valve 30 associated with the high-pressure accumulator 5, as indicated by dotted line 41, is mechanically operable by the second master cylinder piston 8. However, a blocking device 50 is provided in addition, blocking the simulator piston 11 when the high-pressure accumulator 5 is completely emptied and, thus, prevents its movement in the actuating direction. The blocking device 50 is essentially comprised of a hydraulic pressure chamber 42 to which the accumulator pressure can be applied, a piston 43 coupled to a blocking element 44, and a spring 45 biasing the piston 43. A sensor 46 (only represented) is used to monitor the function of the blocking device 50.

All components are shown in their inactive position in FIG. 7. When the brake-by-wire mode of operation fails, valve 30 is switched into its open position by the movement of the second master cylinder piston 8 so that the high-pressure accumulator 5 is partly discharged into the first pressure chamber 9 of the master brake cylinder 2. When the high-pressure accumulator 5 is completely emptied on account of further braking operations and becomes unpressurized as a result, the piston 43 or the blocking element 44 is displaced by the force of the spring 45 in an upward direction in the drawing, whereby the pressure fluid volume taken up in the pressure chamber 42 is displaced back into the high-pressure accumulator 5 and the simulator piston 11 is locked by the blocking element 44.

The designs illustrated in FIGS. 8 and 9 furnish the wheel brakes (not shown) being connected to the HCU as in the examples described hereinabove with only part of the pressure fluid volume taken up by the travel simulator 3. To this end, a valve assembly 47 is interposed between the simulator chamber 14 of the travel simulator 3 and the master brake cylinder 2 in the design shown in FIG. 8, said valve assembly being configured as an electrically operable three-way/two-position directional control valve in the example shown. It is, however, also possible to use a combination of two two-way/two-position directional control valves. In the de-energized switch position of the valve assembly 47, as shown, that corresponds to the fallback mode of operation, the valve assembly establishes a hydraulic connection between the simulator chamber 14 and the wheel brakes of at least one vehicle axle, preferably the rear axle, while the connection between the master brake cylinder 2 and the simulator chamber 14 is interrupted. A non-return valve 48 opening towards the master brake cylinder 2 is inserted into this connection. In contrast thereto, the master brake cylinder 2 is connected to the simulator chamber 14 and separated from the wheel brakes in the brake-by-wire mode of operation.

Finally, a hydraulic connection is provided between the simulator chamber 14 and the wheel brakes in the design illustrated in FIG. 9. The simulator piston 110 has a two-part design and is composed of a stepped piston 51 and an auxiliary piston 52 connected downstream of the stepped piston 51. The surface of the stepped piston 51 of large diameter limits the simulator chamber 14, while its small-diameter surface limits an auxiliary chamber 53. The above-mentioned simulator spring 12 is supported on the auxiliary piston 52. A connection 55 that is closable by means of an electrically operable shut-off valve 54 is arranged between the simulator chamber 14 and the auxiliary chamber 53. The shut-off valve 54 is preferably designed as a normally open (NO) two-way/two-position directional control valve.

The shut-off valve 54 is closed in the brake-by-wire mode of operation so that the stepped piston 51 and the auxiliary piston 52 move synchronously and the simulator spring 12 is compressed when the master brake cylinder 2 is actuated. In the event of power failure, valve 54 is switched over into its open position so that pressure compensation takes place between the simulator chamber 14 and the auxiliary chamber 53. Consequently, the simulator spring can become released and reset the simulator piston 110 so that the pressure fluid volume received by the simulator 3 is delivered to the wheel brakes.

1. Electrohydraulic brake system for motor vehicles which is controllable in a ‘brake-by-wire’ mode of operation by the vehicle operator as well as irrespective of the vehicle operator, is preferably operated in the brake-by-wire mode of operation, and can be operated in a fallback mode of operation in which only operation by the vehicle operator is possible, including
a master brake cylinder operable by means of a brake pedal and having at least one pressure chamber,
a travel simulator cooperating with the master brake cylinder and having a simulator piston positioned by means of a spring, said simulator piston limiting a simulator chamber accommodating the spring, on the one hand, and a simulator chamber communicating with one of the pressure chambers of the master brake cylinder, on the other hand,
an unpressurized pressure fluid reservoir,
a hydraulic auxiliary pressure source,
an electronic controlling and regulating unit, and
wheel brakes connectable to the master brake cylinder and the hydraulic pressure source,
characterized in that a means is provided for making available a pressure fluid volume flow that ensures in the fallback mode of operation at least the pressure fluid volume needed for the respectively required deceleration.

2. Electrohydraulic brake system as claimed in claim 1,
characterized in that the means safeguards a return delivery of the pressure fluid volume taken up by the travel simulator (3) into the master brake cylinder (2).

3. Electrohydraulic brake system as claimed in claim 2,
characterized in that the return delivery is effected by means of the energy generated by the hydraulic auxiliary pressure source (5).

4. Electrohydraulic brake system as claimed in claim 3,
characterized in that the auxiliary pressure source is a chargeable high-pressure accumulator (5), and that a valve assembly (16, 17) is provided which, in the brake-by-wire mode of operation, opens a hydraulic connection between the simulator chamber (13) and the pressure fluid reservoir (4) and closes a hydraulic connection between the simulator chamber (13) and the high-pressure accumulator (5), while it closes the hydraulic connection between the simulator chamber (13) and the pressure fluid reservoir (4) and opens the hydraulic connection between the simulator chamber (13) and the high-pressure accumulator (5) in the fallback mode of operation.

5. Electrohydraulic brake system as claimed in claim 4,
characterized in that, in the fallback mode of operation, the simulator piston (11) is acted upon by the pressure provided by the high-pressure accumulator (5) in opposition to its direction of movement that corresponds to the brake-by-wire mode of operation.

6. Electrohydraulic brake system as claimed in claim 3,
characterized in that the auxiliary pressure source is a chargeable high-pressure accumulator (5), and that a valve assembly (16′, 17′) is provided which, in the brake-by-wire mode of operation, opens a hydraulic connection between a hydraulic chamber (20) of a piston-and-cylinder assembly (18) and the pressure fluid reservoir (4) and closes a hydraulic connection between the hydraulic chamber (20) and the high-pressure accumulator (5), while it closes the hydraulic connection between the hydraulic chamber (20) and the pressure fluid reservoir (4) and opens the hydraulic connection between the hydraulic chamber (20) and the high-pressure accumulator (5) in the fallback mode of operation, the said hydraulic chamber (20) being limited by a hydraulic piston (19) to which the pressure provided by the high-pressure accumulator (5) is applied and which, in the fallback mode of operation, displaces the simulator piston (11) in opposition to its direction of movement that corresponds to the brake-by-wire mode of operation.

7. Electrohydraulic brake system as claimed in claim 3,
characterized in that the auxiliary pressure source is a chargeable high-pressure accumulator (5), and that the simulator piston (11) in the fallback mode of operation, in opposition to its direction of movement that corresponds to the brake-by-wire mode operation, is displaced by a mechanical actuating element (21) that is operated by means of a resetting spring (22) adapted to be compressed by the pressure provided by the high-pressure accumulator (5).

8. Electrohydraulic brake system as claimed in claim 7,
characterized in that part of the actuating element (21) is configured as a hydraulic piston (23).

9. Electrohydraulic brake system as claimed in claim 8,
characterized in that the hydraulic piston (23) separates a first pressure chamber (24) from a second pressure chamber (25), and that a valve assembly (16, 17) is provided that opens a hydraulic connection between the first pressure chamber (24) and the high-pressure accumulator (5) and closes a hydraulic connection between the first pressure chamber (24) and the pressure fluid reservoir (4) in the brake-by-wire mode of operation, while it closes the hydraulic connection between the first pressure chamber (24) and the high-pressure accumulator (5) and opens the hydraulic connection between the first pressure chamber (24) and the pressure fluid reservoir (4) in the fallback mode of operation.

10. Electrohydraulic brake system as claimed in claim 1,
characterized in that the means safeguard inflow of additional pressure fluid volume into the master brake cylinder (2).

11. Electrohydraulic brake system as claimed in claim 10,
characterized in that said additional pressure fluid volume is provided by the hydraulic auxiliary pressure source (5).

12. Electrohydraulic brake system as claimed in claim 11,
characterized in that a hydraulic connection (29) closable by means of a valve (30) is interposed between the auxiliary pressure source (5) and at least one of the pressure chambers (9, 10) of the master brake cylinder (2).

13. Electrohydraulic brake system as claimed in claim 12,
characterized in that a separating piston device (33) is inserted into the hydraulic connection (29) and connected to the pressure fluid reservoir (4) by means of a closable line.

14. Electrohydraulic brake system as claimed in claim 12,
characterized in that the master brake cylinder (2) is configured as a tandem master cylinder with a first (9) and a second pressure chamber (10) being limited by a first (7) and a second piston (9), and that the valve (30) is operable by the movement of the second piston (8).

15. Electrohydraulic brake system as claimed in any one of claims 10 to 14,
characterized in that the simulator chamber (14) is connected to the simulator chamber (13) by means of a closable line.

16. Electrohydraulic brake system as claimed in claim 14 or 15,
characterized in that the line connecting the simulator chamber (13) to the pressure fluid reservoir (4) is adapted to be closed or opened by means of a shut-off valve (31) that is operable by movement to the second master cylinder piston (8).

17. Electrohydraulic brake system as claimed in claim 14,
characterized in that there is provision of a blocking device (50) preventing the movement of the simulator piston (11) in the actuating direction when the high-pressure accumulator (5) is completely emptied.

18. Electrohydraulic brake system as claimed in claim 1,
characterized in that the means in the fallback mode of operation supply at least part of the pressure fluid volume received in the travel simulator (3) to the wheel brakes.

19. Electrohydraulic brake system as claimed in claim 18,
characterized in that a valve assembly (47) is provided which, in the brake-by-wire mode of operation, establishes a connection between the master brake cylinder (2) and the simulator chamber (14) and closes a connection between the wheel brakes and the simulator chamber (14), while it closes the connection between the master brake cylinder (2) and the simulator chamber (14) and establishes the connection between the wheel brakes and the simulator chamber (14) in the fallback mode of operation.

20. Electrohydraulic brake system as claimed in claim 19,
characterized in that, in the fallback mode of operation, a non-return valve (48) opening towards the master brake cylinder (2) is inserted into the connection between the master brake cylinder (2) and the simulator chamber (14) or the wheel brakes.

21. Electrohydraulic brake system as claimed in claim 19 or 20,
characterized in that the wheel brakes are associated to a vehicle axle, preferably the rear axle.

22. Electrohydraulic brake system as claimed in claim 18,
characterized in that the simulator chamber (14) is connected to the wheel brakes, that the simulator piston (110) has a two-part design and is composed of a stepped piston (51) and an auxiliary piston (52) connected downstream of said stepped piston (51), with the surface of the stepped piston (51) of larger diameter limits the simulator chamber (14), while its small-diameter surface along with the auxiliary piston (52) limits an auxiliary chamber (53), the said simulator spring (12) being supported on the auxiliary piston (52) and with a connection (55) being arranged between the simulator chamber (14) and the auxiliary chamber (53).

23. Electrohydraulic brake system as claimed in claim 22,
characterized in that an electrically operable, normally open (NO) two-way/two-position directional control valve (54) is inserted into the closable connection (55).
